(19) United States
(12) Patent Application Publication
(10) Pub. No.: US 2022/0016682 A1
(43) Pub. Date: Jan. 20, 2022

(54) ADJUSTMENT DEVICE

(71) Applicant: SAMSUNG ELECTRONICS CO., LTD., Suwon-si (KR)

(72) Inventor: Jin Sung Kim, Suwon-si (KR)

(73) Assignee: SAMSUNG ELECTRONICS CO., LTD., Suwon-si (KR)

(21) Appl. No.: 17/488,440

(22) Filed: Sep. 29, 2021

Related U.S. Application Data
(63) Continuation of application No. PCT/KR2019/006178, filed on May 23, 2019.

(30) Foreign Application Priority Data
Mar. 29, 2019 (KR) 10-2019-0036946

(51) Int. Cl. B21D 3/14; B21D 3/10; B21D 7/025

(52) U.S. Cl. CPC B21D 3/14; B21D 7/025; B21D 3/10

(57) ABSTRACT

The present disclosure relates to an adjustment device for adjusting a bending angle of a stand for a display device. The adjustment device includes a base on which a stand useable for a display device is to be seated, a plate including a first plate provided to support the base and a second plate provided to be movable toward the first plate, a block formed to protrude from the second plate toward the first plate, and a crank having a first end formed so that as the first end is pressed by the block moving together with the second plate toward the first plate, a second end of the crank presses an inner surface of the stand in order to adjust an angle of the stand.

### CROSS-REFERENCE TO RELATED APPLICATION

This application is a continuation application, under 35 U.S.C. § 111(a), of International Patent Application No. PCT/KR2019/006178, filed May 23, 2019, which claims the foreign priority benefit under 35 U.S.C. § 119 to Korean Patent Application No. 10-2019-0036946, filed May 29, 2019, the contents of both of which are incorporated by reference herein in their entirety.

### FIELD

The present disclosure relates to an adjustment device for adjusting a bending angle of a stand for a display device.

### BACKGROUND

A display device is a device that displays visual and three-dimensional image information.

The display device may include all devices implemented in various forms, for example, a portable multimedia device such as a digital broadcasting terminal, a personal digital assistant (PDA), and a portable multimedia player (PMP), and a portable communication device such as a smartphone and a wearable device, as well as a television (TV) and a monitor.

The display device may be supported by a stand mounted at a lower end thereof, and may be installed on a wall by a separate bracket or the like.

The stand may be implemented as a U-bending angle of a ‘U’ shape by shearing a metal plate in a press mold. The bending angle of the metal plate may be closely related to an inclination of the display device.

In a general method of post-adjusting a bending angle of a metal plate bent from a press mold, when the bending angle is larger than a target value, a method of pressing an upper portion of the metal plate with a force corresponding to a value restored depending on an expected springback value of the metal plate may be applied.

However, the value may not be uniform due to the difference in the springback of the metal plate, and conversely, when the bending angle is smaller than the target value, the post-angle adjustment is difficult, which may lead to product defects.

### SUMMARY

An aspect of the present disclosure provides an adjustment device including a base on which a stand useable for a display device is to be seated, a plate including a first plate provided to support the base and a second plate provided to be movable toward the first plate, a block formed to protrude from the second plate toward the first plate, and a crank having a first end formed so that as the first end is pressed by the block moving together with the second plate toward the first plate, a second end of the crank presses an inner surface of the stand to adjust an angle of the stand.

The crank may include a crank in which the first end is pressed by the block, and a crank shaft provided to penetrate the crank body so that the crank body pivots.

The crank may further include a pad shaft provided at the second end, and a pad coupled to the pad shaft to rotate together with the pad shaft.

The pad may be configured to be in surface contact with the inner surface of the stand.

The adjustment device may further include a clamp provided on the base so that the stand is supported on the base.

The adjustment device may further include an elastic member disposed between the second plate and the clamp to elastically move the second plate.

The stand may include a first stand supported by the clamp, a second stand bent from the first stand, and a third stand bent from the second stand, and the pad may be disposed to press an inner surface of the third stand.

The pad may be configured to adjust a first angle between the second stand and the third stand.

A second angle between the first stand and the second stand may be formed to be adjusted together by the pad configured to adjust the first angle.

The block may include a first block provided to press the first end, and a second block provided to press an outer surface of the third stand.

The second block may be detachably coupled to the second plate or the base.

The second block may press the outer surface of the third stand so that the first angle becomes small.

The pad may press the inner surface of the third stand so that the first angle becomes large.

In a state in which the first block presses the first end and the second block presses the outer surface of the third stand, the inner surface of the third stand and the pad may be spaced apart from each other.

The second block may include an inclined surface in contact with the outer surface of the third stand.

### BRIEF DESCRIPTION OF THE DRAWINGS

FIG. 1 is a perspective view of a display device to which a stand in which a bending angle is adjusted by an adjustment device according to the present disclosure may be applied.

FIG. 2 is a perspective view of the stand in which the bending angle is adjusted by the adjustment device according to the present disclosure.

FIG. 3 is a side view of the stand in which the bending angle is adjusted by the adjustment device according to the present disclosure.

FIG. 4 is a view illustrating the adjustment device according to the present disclosure.

FIG. 5 is a view illustrating a first plate including a block in the adjustment device according to the present disclosure.

FIG. 6 is a view illustrating a second plate including a crank in the adjustment device according to the present disclosure.

FIG. 7 is a view illustrating a state before a first block presses a crank body in the adjustment device according to the present disclosure.

FIG. 8 is a view illustrating a state after the first block presses the crank body in the adjustment device according to the present disclosure.

FIG. 9 is a view illustrating a state before a second block presses the stand in the adjustment device according to the present disclosure.

FIG. 10 is a view illustrating a state after the second block presses the stand in the adjustment device according to the present disclosure.

### DETAILED DESCRIPTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise.

The terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another.

For example, without departing from the scope of the present disclosure, the first component may be referred as a second component, and similarly, the second component may also be referred to as a first component. The term “and/or” includes any combination of a plurality of related items or any one of a plurality of related items.

In this specification, the terms “front end,” “rear end,” “upper portion,” “lower portion,” “upper end” and “lower end” used in the following description are defined with reference to the drawings, and the shape and position of each component are not limited by these terms.

The present disclosure is directed to providing an improved adjustment device to adjust a bending angle of a stand for a display device.

The present disclosure is directed to providing an improved adjustment device to adjust a bending angle of a stand for a display device when the bending angle of the stand is larger or smaller than a target value.

The present disclosure is directed to providing an improved adjustment device to ensure a degree of freedom to change a design of a stand for a display device.

An adjustment device according to the present disclosure can adjust a bending angle of a stand for a display device.

The adjustment device according to the present disclosure can secure a degree of freedom to change a design of the stand during development or mass production of the stand for the display device.

The adjustment device according to the present disclosure can prevent product defects and increase product productivity by adjusting the bending angle of the stand when the bending angle of the stand is smaller than a target value.

Hereinafter, embodiments of the present disclosure will be described in detail with reference to the accompanying drawings.

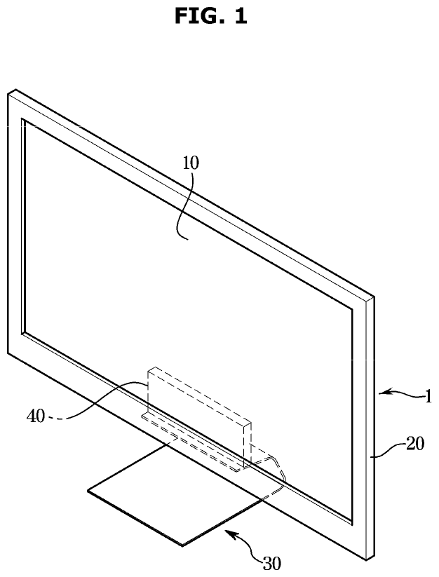

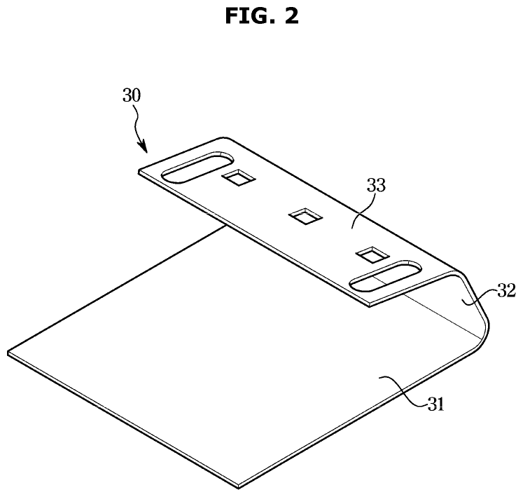

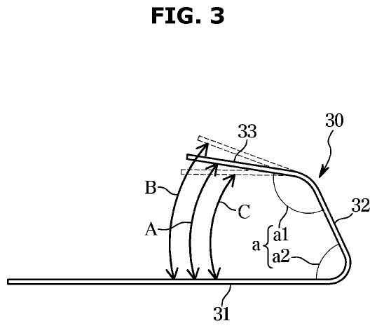

FIG. 1 is a perspective view of a display device to which a stand in which a bending angle is adjusted by an adjustment device according to the present disclosure may be applied. FIG. 2 is a perspective view of the stand in which the bending angle is adjusted by the adjustment device according to the present disclosure. FIG. 3 is a side view of the stand in which the bending angle is adjusted by the adjustment device according to the present disclosure.

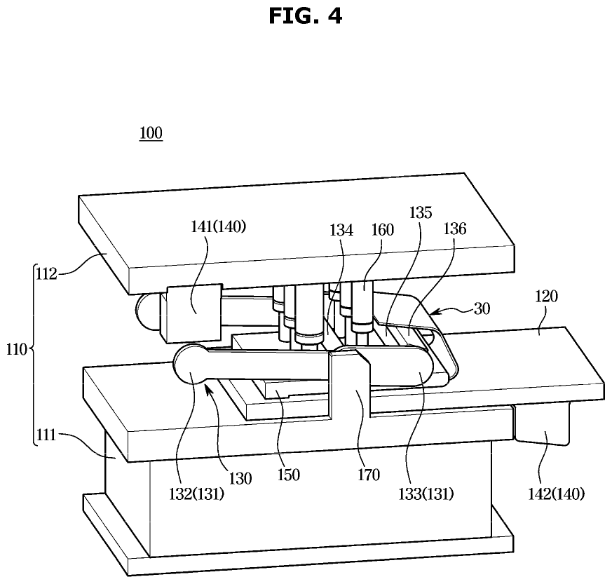

As illustrated in FIGS. 1 to 3, a stand 30 in which a bending angle is adjusted by an adjustment device 100 (see FIG. 4) according to the present disclosure may be used for a display device 1. However, the present disclosure is not limited thereto, and the stand 30 may be applied to various electronic products within a limit of supporting the electronic products.

Hereinafter, for convenience of description, the stand 30 for the display device 1 will be described.

The display device 1 may display an image and output a sound. The sound may be output through an external device.

The display device 1 may be supported by the stand 30 mounted at a lower end thereof, and may be installed on a wall by a separate bracket (not shown) or the like. The display device 1 may include a display panel 10 and a chassis 20 provided to cover the display panel 10.

The display device 1 may be supported by being coupled to a separate connection member 40 connecting a rear surface of the chassis 20 and the stand 30. However, the present disclosure is not limited thereto, and the display device 1 may be supported by directly coupling the rear surface of the chassis 20 to the stand 30.

The chassis 20 may include a front chassis provided to cover one side of the display panel 10 and a rear chassis provided to cover the other side of the display panel 10.

The rear chassis may be provided to cover the rear of the display panel 10, and the front chassis may be provided to cover the front of the display panel 10.

Various input/output devices, etc. may be mounted on the rear chassis, which is a chassis that connects various components necessary for image display and sound output.

The rear chassis may be made of a metal having excellent heat dissipation and strength. The rear chassis may include a flat plate shape. However, the present disclosure is not limited thereto.

The front chassis may support the display panel 10. The front chassis may fix the display panel 10 and may be detachably coupled to the rear chassis.

The front chassis may support an edge of the display panel 10 so that at least a portion of the front of the display panel 10 may be exposed to the outside. However, the present disclosure is not limited thereto.

The front chassis may form an accommodating space when combined with the rear chassis, and the display panel 10 and the like may be disposed in the accommodating space.

The stand 30 may include a metal material. The stand 30 may be formed by processing a metal plate by a press mold.

The stand 30 may include a first stand 31, a second stand 32 bent from the first stand 31, and a third stand 33 bent from the second stand 32.

The first stand 31 may have a planar shape to be in contact with a bottom surface supporting the display device 1. The second stand 32 may be bent upward from the first stand 31.

The third stand 33 may be bent downward from the second stand 32. The third stand 33 may be bent from the second stand 32 toward the first stand 31. However, the present disclosure is not limited thereto.

The second stand 32 may be bent to have a predetermined angle a from the first stand 31. The third stand 33 may be bent to have the predetermined angle a from the second stand 32.

The predetermined angle a may include a first angle a1 between the second stand 32 and the third stand 33, and a second angle a2 between the first stand 31 and the second stand 32.

The third stand 33 may include a plurality of coupling holes so that the connection member 40 coupled to the rear surface of the chassis 20 is coupled to support the display device 1. However, the present disclosure is not limited thereto.

The stand 30 supporting the display device 1 may have a close influence on an inclination of the display panel 10. In particular, while the second angle a2 is related to a design element of the stand 30, the first angle a1 may be closely related to the inclination of the display panel 10.

Therefore, forming the stand 30 by a press mold to coincide the first angle a1 with a target value may be important to a user watching the display device 1 through the display panel 10.

However, due to an error of a springback value depending on the bending of the stand 30 including the metal material in a process of forming the stand 30 to have the first angle a1 by a press mold, it may be difficult to realize the first angle a1 to be targeted.

Due to this, unlike a case A in which the first angle a1 to be targeted is implemented, a case B in which the first angle a1 is larger than the target value or a case C in which the first angle a1 is smaller than the target value may occur.

Therefore, when the first angle a1 is larger than the target value (B) or smaller than the target value (C), it may be necessary to post-adjust the first angle a1 to coincide with the target value.

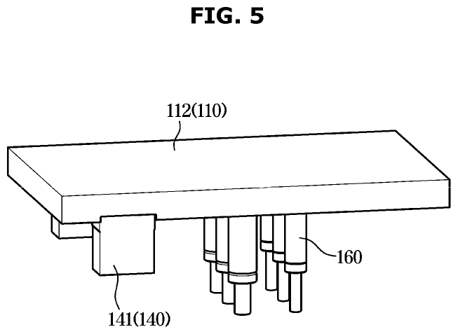

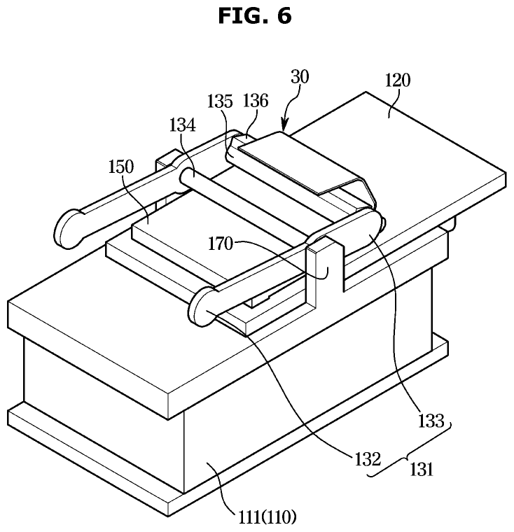

FIG. 4 is a view illustrating the adjustment device according to the present disclosure. FIG. 5 is a view illustrating a first plate including a block in the adjustment device according to the present disclosure. FIG. 6 is a view illustrating a second plate including a crank in the adjustment device according to the present disclosure.

As illustrated in FIGS. 4 to 6, the adjustment device 100 according to the present disclosure may adjust the bending angle of the stand 30. The adjustment device 100 may include a plate 110 and a base 120 seated on the plate 110.

The plate 110 may include a first plate 111 provided on one side of the base 120 and a second plate 112 provided on the other side of the base 120.

The first plate 111 may be disposed below the base 120, and the second plate 112 may be disposed above the base 120. The base 120 may be coupled to the first plate 111.

The stand 30 may be seated on the base 120. The first plate 111 may be fixed to an installation surface on which the adjustment device 100 is installed, and the second plate 112 may be provided to be movable.

The second plate 112 may move toward the first plate 111. The second plate 112 may move in an up-down direction. The second plate 112 may move in a vertical direction.

The adjustment device 100 may include a clamp 150 provided on the base 120 so that the stand 30 is supported on the base 120. The clamp 150 may fix one side of the stand 30. The clamp 150 may support the first stand 31 (refer to FIG. 3).

The stand 30 may be disposed between the base 120 and the clamp 150. The clamp 150 may have a substantially “¬” shape. However, the present disclosure is not limited thereto. The first stand 31 may be inserted between the base 120 and the clamp 150.

The adjustment device 100 may include an elastic member 160 provided on the second plate 112 so that the second plate 112 moves elastically. The elastic member 160 may be disposed between the second plate 112 and the clamp 150. However, the present disclosure is not limited thereto.

A plurality of the elastic member 160 may be provided. The elastic member 160 may include a gas spring. However, the present disclosure is not limited thereto. The second plate 112 may be moved downward toward the first plate 111 by a separate driving member (not shown) and then restored to an original position thereof by the elastic member 160.

The adjustment device 100 may include a crank 130 configured to adjust the bending angle of the stand 30, and a block 140 provided to press the crank 130.

The block 140 may include a first block 141 provided on the second plate 112, and a second block 142 detachably coupled to the second plate 112. The first block 141 may be fixed to the second plate 112. The block 140 may be coupled to a lower portion of the second plate 112.

The block 140 may be provided on the second plate 112 to face the first plate 111. The second block 142 may be detachably coupled to the base 120. The second block 142 may be disposed below the base 120. However, the present disclosure is not limited thereto.

Therefore, the first block 141 is coupled to one end of the second plate 112, but the second block 142 may be coupled to the other end of the second plate 112 only when used, and may be coupled to a lower portion of the base 120 when not in use. However, the present disclosure is not limited thereto.

The crank 130 may include a crank body 131 pressed by the block 140. Two of the crank bodies 131 may be provided to face each other. The crank 130 may include a crank shaft 134 provided to penetrate the crank body 131 so that the crank body 131 pivots.

The crank shaft 134 may connect two of the crank bodies 131 facing each other. The adjustment device 100 may include a support member 170 coupled to the crank shaft 134 penetrating the crank body 131.

The crank shaft 134 may be rotatably coupled to the support member 170. The support member 170 may protrude from the first plate 111. The support member 170 may protrude upward from the first plate 111. Two of the support members 170 may be provided to support opposite ends of the crank shaft 134.

The crank body 131 may include a first end 132 pressed by the first block 141 that is moved together with the second plate 112, and a second end 133 provided to press the stand 30.

The crank 130 may include a pad shaft 135 provided on the second end 133 of the crank body 131, and a pad 136 coupled to the pad shaft 135 to press the stand 30. The pad shaft 135 may rotate about the second end 133 of the crank body 131.

The pad 136 may be coupled to the pad shaft 135 to be rotatable together with the pad shaft 135. The pad 136 may extend in an axial direction of the pad shaft 135. The pad 136 may have a rectangular shape. However, the present disclosure is not limited thereto.

The first end 132 may have a circular shape. However, the present disclosure is not limited thereto.

The crank body 131 may pivot about the crank shaft 134. Therefore, when the first end 132 moves downward, the second end 133 may move upward, and when the second end 133 moves downward, the end first 132 may move upward.

That is, the adjustment device 100 according to the present disclosure may axially rotate the crank body 131 about the crank shaft 134 by applying the principle of the lever.

The crank shaft 134 may be disposed closer to the second end 133 than the first end 132. Accordingly, an amount of indirect movement of the second end 133 may be smaller than an amount of movement of the first end 132 by the pressing of the first block 141. However, the present disclosure is not limited thereto.

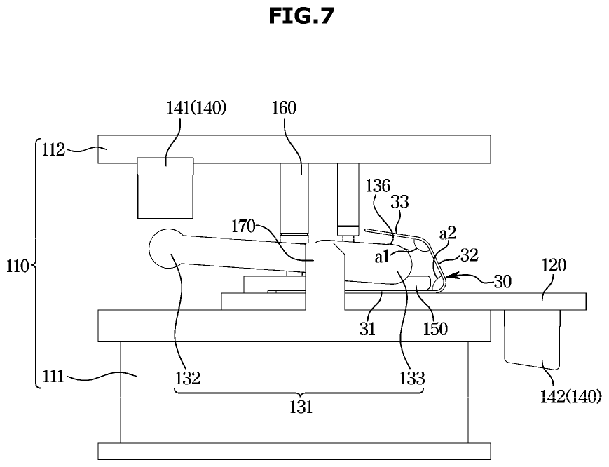

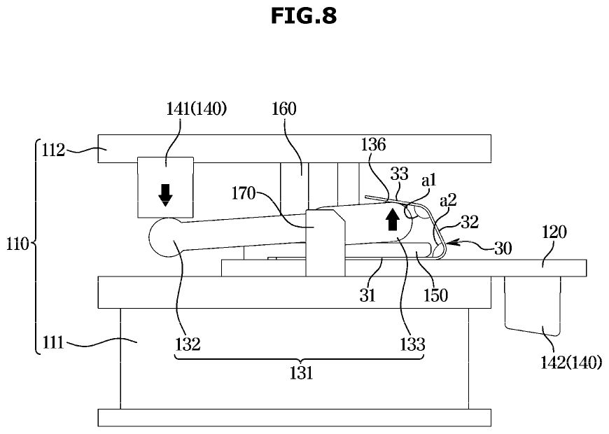

FIG. 7 is a view illustrating a state before a first block presses a crank body in the adjustment device according to the present disclosure. FIG. 8 is a view illustrating a state after the first block presses the crank body in the adjustment device according to the present disclosure.

Hereinafter, unlike the case A in which the first angle a1 is implemented to the target value (see FIG. 3), an operation of adjusting the first angle a1 in the case C (see FIG. 3) in which the first angle a1 is smaller than the target value will be described in detail.

As illustrated in FIGS. 7 and 8, the stand 30 may be seated on the base 120 and supported by the clamp 150. The second plate 112 may move toward the first plate 111, and the first block 141 provided on the second plate 112 may be moved together with the second plate 112.

The movement of the second plate 112 may be performed by an electrical driving through a separate driving member (not shown) or by a mechanical driving according to a mechanism. However, the present disclosure is not limited thereto.

The first block 141 being moved may press the first end 132 of the crank body 131 downward, and thus the crank body 131 may pivot counterclockwise about the crank shaft 134 (see FIG. 6).

Accordingly, the second end 133 of the crank body 131 may be moved upward. Therefore, an inner surface of the stand 30 may be pressed by the pad shaft 135 (see FIG. 6) and the pad 136 provided at the second end 133.

An inner surface of the third stand 33 may be pressed by the pad 136, and the first angle a1 formed smaller than the target value may be increased to coincide with the target value. At this time, the second angle a2 may also be increased.

That is, while the first stand 31 is fixed between the base 120 and the clamp 150, as the pad 136 presses the inner surface of the third stand 33, the third stand 33 and the second stand 32 may be bent.

Accordingly, the first angle a1 and the second angle a2 may be changed together by the pad 136.

However, because the second angle a2 may be related to a design element, and the first angle a1 is related to an angle at which the display panel 10 (see FIG. 1) is supported, the adjustment device 100 (see FIG. 4) according to the present disclosure may be configured to coincide the first angle a1 rather than the second angle a2 with the target value.

The pad 136 may be configured to be in surface contact with the inner surface of the stand 30. The pad 136 may be configured to be in surface contact with the inner surface of the third stand 33.

Because the third stand 33 has the first angle a1 and may be bent to be inclined from the second stand 32, the pad 136 having a substantially rectangular shape and the inner surface of the third stand 33 may not be in surface contact, and may be in line contact in some cases.

When the pad 136 and the inner surface of the third stand 33 are in line contact, the inner surface of the third stand 33 or the pad 136 may be damaged due to repeated collisions.

Accordingly, the pad 136 is coupled to the second end 133 to be rotatable together with the pad shaft 135, so that the pad 136 may be in surface contact with the inner surface of the third stand 33 having the first angle a1.

In the case (C) in which the first angle a1 is smaller than the target value, when the first angle a1 is adjusted, the second block 142 may be detached from the second plate 112 and coupled to the base 120 to prevent collision with an outer surface of the third stand 33 by being moved together with the second plate 112.

Therefore, the adjustment device 100 according to the present disclosure may adjust the first angle a1 to the target value without any damage to an exterior of the stand 30 in the case (C) in which the first angle a1 formed smaller than the target value.

In addition, the adjustment device 100 may efficiently adjust the first angle a1 by using the principle of the lever through the crank shaft 134 so that without directly adjusting the stand 30, the first end 132 is pressed and then the second end 133 presses the stand 30.

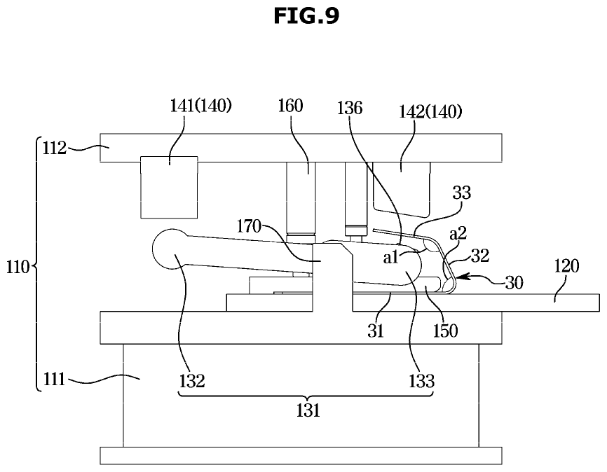

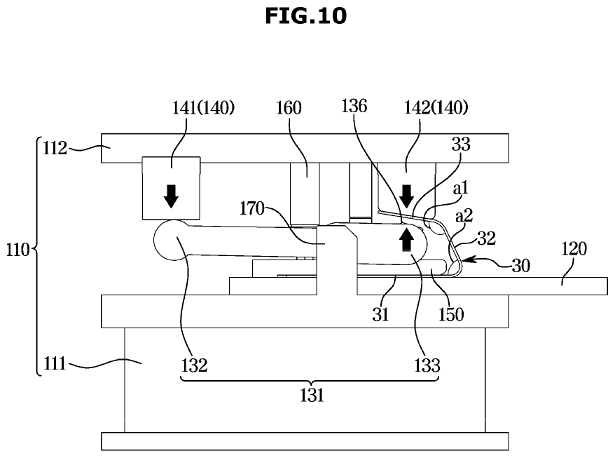

FIG. 9 is a view illustrating a state before a second block presses the stand in the adjustment device according to the present disclosure. FIG. 10 is a view illustrating a state after the second block presses the stand in the adjustment device according to the present disclosure.

Hereinafter, unlike the case A in which the first angle a1 is implemented to the target value, an operation of adjusting the first angle a1 in the case B in which the first angle a1 is larger than the target value will be described in detail.

As illustrated in FIGS. 9 and 10, the stand 30 may be seated on the base 120 and supported by the clamp 150. The second plate 112 may move toward the first plate 111, and the first block 141 and the second block 142 provided on the second plate 112 may be moved together with the second plate 112.

The first block 141 being moved may press the first end 132 of the crank body 131 downward, and thus the crank body 131 may pivot counterclockwise about the crank shaft 134. Accordingly, the second end 133 of the crank body 131 may be moved upward.

The second block 142 moving together with the second plate 112 may press the outer surface of the third stand 33 downward. Accordingly, the first angle a1 formed larger than the target value may be reduced to coincide with the target value. At this time, the second angle a2 may also be reduced.

That is, while the first stand 31 is fixed between the base 120 and the clamp 150, as the second block 142 presses the outer surface of the third stand 33, the third stand 33 and the second stand 32 may be bent. Accordingly, the first angle a1 and the second angle a2 may be changed together

The second block 142 may be shorter than the first block 141. The second block 142 may have a shorter length protruding from the lower portion of the second plate 112 than the first block 141.

The pad shaft 135 and the pad 136 provided at the second end 133 may be spaced apart from the inner surface of the third stand 33. That is, when the second block 142 presses the outer surface of the third stand 33 downward to adjust the first angle a1, the pad 136 may not press the inner surface of the third stand 33 upward.

Accordingly, as the second plate 112 and the second block 142 move excessively downward to press the outer surface of the third stand 33, the pad 136 may prevent the first angle a1 from not coinciding with the target value from the state B in which the first angle a1 is larger than the target value, and from becoming the case C in which the first angle a1 is smaller than the target value.

That is, the third stand 33 pressed by the second block 142 may be pressed by the pad 136 to form a limit at which the first angle a1 may be reduced.

Accordingly, the adjustment device 100 according to the present disclosure may easily adjust the first angle a1 to the target value not only in the case C in which the first angle a1 is formed smaller than the target value, but also in the case B in which the first angle a1 is formed larger than the target value.

The second block 142 may include an inclined surface in contact with the outer surface of the third stand 33.

Because the third stand 33 may be bent to be inclined from the second stand 32 with the first angle a1, when the second block 141 has a substantially rectangular shape without an inclined surface, the second block 141 and the outer surface of the third stand 33 may not be in surface contact, but may be in line contact.

When the second block 141 and the outer surface of the third stand 33 are in line contact, the outer surface of the third stand 33 or the second block 142 may be damaged.

In order to prevent this, the second block 142 may be in surface contact with the outer surface of the third stand 33 having the first angle a1 by including the inclined surface.

In the adjustment device 100 according to the present disclosure, using a single device, the pad 136 presses the inner surface of the third stand 33 so that the first angle a1 increases, or the second block 142 presses the outer surface of the third stand 33 so that the first angle a1 decreases, so that not in the case A in which the first angle a1 is formed to a target value, in the case B in which the first angle a1 is formed larger than the target value, or in the case C in which the first angle a1 is formed smaller than the target value, the first angle a1 may be simply post-adjusted.

Although the technical idea of the present disclosure has been described above by way of specific embodiments, the scope of the present disclosure is not limited to these embodiments.

Various embodiments that may be modified by those skilled in the art of the present disclosure would also be within the scope of the present disclosure, without departing from the gist of the present disclosure specified in the claims.

What is claimed is:

1. An adjustment device comprising:
a base on which a stand useable for a display device is to be seated;
a plate including a first plate provided to support the base and a second plate provided to be movable toward the first plate;
a block formed to protrude from the second plate toward the first plate; and
a crank having a first end formed so that as the first end is pressed by the block moving together with the second plate toward the first plate, a second end of the crank presses an inner surface of the stand to adjust an angle of the stand.

2. The adjustment device according to claim 1, wherein
the crank includes a crank body in which the first end is pressed by the block, and a crank shaft provided to penetrate the crank body so that the crank body pivots.

3. The adjustment device according to claim 2, wherein
the crank further includes a pad shaft provided at the second end, and a pad coupleable to the pad shaft and rotatable together with the pad shaft.

4. The adjustment device according to claim 3, wherein
the pad is configured to be in surface contact with the inner surface of the stand.

5. The adjustment device according to claim 3, further comprising:
a clamp provided on the base so that the stand is supported on the base.

6. The adjustment device according to claim 5, further comprising:
an elastic member disposed between the second plate and the clamp to elastically move the second plate.

7. The adjustment device according to claim 5, wherein
the stand includes a first stand to be supported by the clamp, a second stand formed to be bent from the first stand, and a third stand bent from the second stand, and
the pad is disposed to press an inner surface of the third stand.

8. The adjustment device according to claim 7, wherein
the pad is configured to adjust a first angle between the second stand and the third stand.

9. The adjustment device according to claim 8, wherein
a second angle between the first stand and the second stand is formed to be adjusted together by the pad configured to adjust the first angle.

10. The adjustment device according to claim 8, wherein
the block includes a first block provided to press the first end, and a second block provided to press an outer surface of the third stand.

11. The adjustment device according to claim 10, wherein
the second block is coupleable to and decoupleable from the second plate or the base.

12. The adjustment device according to claim 10, wherein
the second block presses the outer surface of the third stand so that the first angle becomes small.

13. The adjustment device according to claim 8, wherein
the pad presses the inner surface of the third stand so that the first angle becomes large.

14. The adjustment device according to claim 10, wherein
in a state in which the first block presses the first end and the second block presses the outer surface of the third stand, the inner surface of the third stand and the pad are spaced apart from each other.

15. The adjustment device according to claim 10, wherein
the second block includes an inclined surface in contact with the outer surface of the third stand.
